(19) United States
(12) Patent Application Publication
(10) Pub. No.: US 2008/0301614 A1
(43) Pub. Date: Dec. 4, 2008

(54) METHOD, SYSTEM, AND COMPUTER PROGRAM PRODUCT FOR SPARE CIRCUITRY DISTRIBUTION

(75) Inventors: Eddy St. Juste, Bridgeport, CT (US); Moussadek Belaidi, Fishkill, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/757,465

(22) Filed: Jun. 4, 2007

(51) Int. Cl. G06F 17/50

(52) U.S. Cl. 716/11

(57) ABSTRACT

A method, system, and computer program product for spare circuitry distribution in an integrated circuit design are provided. The method includes receiving design data for the integrated circuit design. The design data includes descriptions of spare circuitry and physical area available for circuitry placement. The method further includes determining target placement locations for the spare circuitry, where the target placement locations create a balanced distribution of the spare circuitry throughout the physical area available for circuitry placement. The method also includes shifting the location of the spare circuitry from each target placement location towards a nearest clock block within the integrated circuit design, resulting in an updated integrated circuit design. The method additionally includes outputting the updated integrated circuit design.

### BACKGROUND OF THE INVENTION

The present disclosure relates generally to integrated circuit design tools, and, in particular, to spare circuitry distribution in an integrated circuit design.

In designing integrated circuits, such as application specific integrated circuits (ASICs), programmable logic devices (PLDs), microprocessors, microcontrollers, memory devices, and the like, spare circuitry is often incorporated early in the design process to support additions or changes as the design matures. While adding spare circuitry to a design increases flexibility for future modifications, it is difficult to determine where to place the spare circuitry such that it can be effectively utilized in the future. A common approach is to place all required circuitry first and then place spare circuitry in an arbitrary available location within the integrated circuit. This approach can lead to clustering spare circuitry in areas of the integrated circuit where the spare circuitry is not readily accessible when needed. Some spare circuitry is specifically intended to adjust for timing issues that can appear when a design is physically placed within an integrated circuit. However, if the spare circuitry is not in physical proximity to a circuit that needs to utilize the spare circuitry, additional timing delays can accrue due to the distance between the spare circuitry and the circuit that utilizes it. The additional timing delays make successful utilization of the spare circuitry difficult.

Another approach to placing spare circuitry is to identify locations next to circuits that designers anticipate will be problematic. Identifying potential problem areas with spare circuitry can be time consuming for designers, involving a substantial effort to locate potential problem areas and carefully integrate and/or hand place the spare circuitry in those areas. This approach is sometimes helpful, but unanticipated problems often arise near non-identified circuits due to design issues, layout and routing constraints, or requirements changes. Thus, both the clustering approach and the identifying potential problem areas approach to placing spare circuitry within an integrated circuit may be ineffective in practice. Accordingly, there is a need in the art for automated spare circuitry distribution in an integrated circuit design.

### BRIEF SUMMARY OF THE INVENTION

An embodiment of the invention includes a method for spare circuitry distribution in an integrated circuit design. The method includes receiving design data for the integrated circuit design. The design data includes descriptions of spare circuitry and physical area available for circuitry placement. The method further includes determining target placement locations for the spare circuitry, where the target placement locations create a balanced distribution of the spare circuitry throughout the physical area available for circuitry placement. The method also includes shifting the location of the spare circuitry from each target placement location towards a nearest clock block within the integrated circuit design, resulting in an updated integrated circuit design. The method additionally includes outputting the updated integrated circuit design.

An additional embodiment includes a system for spare circuitry distribution in an integrated circuit design. The system includes a data storage device holding design data for the integrated circuit design, where the design data includes descriptions of spare circuitry and physical area available for circuitry placement. The system also includes a host system in communication with the data storage device. The host system executes a spare circuitry distribution tool (SCDT). The SCDT receives the design data and determines target placement locations for the spare circuitry. The target placement locations create a balanced distribution of the spare circuitry throughout the physical area available for circuitry placement. The SCDT also shifts the location of the spare circuitry from each target placement location towards a nearest clock block within the integrated circuit design, resulting in an updated integrated circuit design. The SCDT outputs the updated integrated circuit design.

Another embodiment includes a computer program product for spare circuitry distribution in an integrated circuit design. The computer program product includes a storage medium readable by a processing circuit and storing instructions for execution by the processing circuit for implementing a method. The method includes receiving design data for the integrated circuit design, where the design data includes descriptions of spare circuitry and physical area available for circuitry placement. The method also includes determining target placement locations for the spare circuitry. The target placement locations create a balanced distribution of the spare circuitry throughout the physical area available for circuitry placement. The method further includes shifting the location of the spare circuitry from each target placement location towards a nearest clock block within the integrated circuit design, resulting in an updated integrated circuit design. The method additionally includes outputting the updated integrated circuit design.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 depicts an exemplary system for spare circuitry distribution in an integrated circuit design that may be utilized by an exemplary embodiment;

FIG. 2 depicts an exemplary integrated circuit with clustered spare circuitry;

FIG. 3 depicts an exemplary integrated circuit with target spare circuitry distribution and shift direction; and

FIG. 4 depicts an exemplary process flow for spare circuitry distribution in an integrated circuit design.

### DETAILED DESCRIPTION OF THE INVENTION

Exemplary embodiments, as shown and described by the various figures and the accompanying text, provide a method, system and computer program product for spare circuitry distribution in an integrated circuit design. In designing an integrated circuit, spare circuits may be incorporated in the design to provide some margin for future modifications. As the design matures, changes to the original design can occur for a number of reasons, such as design issues, layout and routing constraints, or requirements changes. When spare circuitry is needed to correct or otherwise modify circuit timing, it is beneficial for the spare circuitry to be located in close physical proximity to the circuits that connect to the spare circuitry, as longer paths result in greater delay. Examples of spare circuitry include latches, buffers, clocking structures, and other such elements. While increasing the overall spare circuitry within the design could help mitigate proximity issues, there is increased cost and decreased efficiency when employing a large number of spare circuits. Therefore, applying a spare circuitry placement strategy is a preferable solution to simply increasing the total number of spare circuits.

In an exemplary embodiment, a spare circuitry distribution tool determines a target distribution for spare circuitry through analyzing design data. The design data may include descriptions of spare circuitry and physical area available for circuitry placement. The target distribution spreads the spare circuitry across the physical area available for circuitry placement to establish a balanced distribution. The balanced distribution need not be perfectly symmetric and may take other factors into account, such as preferred regions of the integrated circuit to locate spare circuitry. In an exemplary embodiment, the balanced distribution approximates a checkerboard pattern. Once the target locations for the spare circuitry are determined, the placement locations are shifted to better align the spare circuitry with other circuits in the design. In an exemplary embodiment, the spare circuitry is shifted towards the nearest clock block in the design, e.g., a local clock block. Placing the spare circuitry near clock blocks increases the probability that the spare circuitry will be in close proximity to other circuits that may need to interface with the spare circuitry in the future. The spare circuitry distribution tool or a separate logic synthesizer can shift the spare circuitry towards the nearest clock block, applying an optional relative weighting to adjust the strength of attraction between the spare circuitry and the nearest clock block. Further details regarding spare circuitry distribution in an integrated circuit design are provided herein.

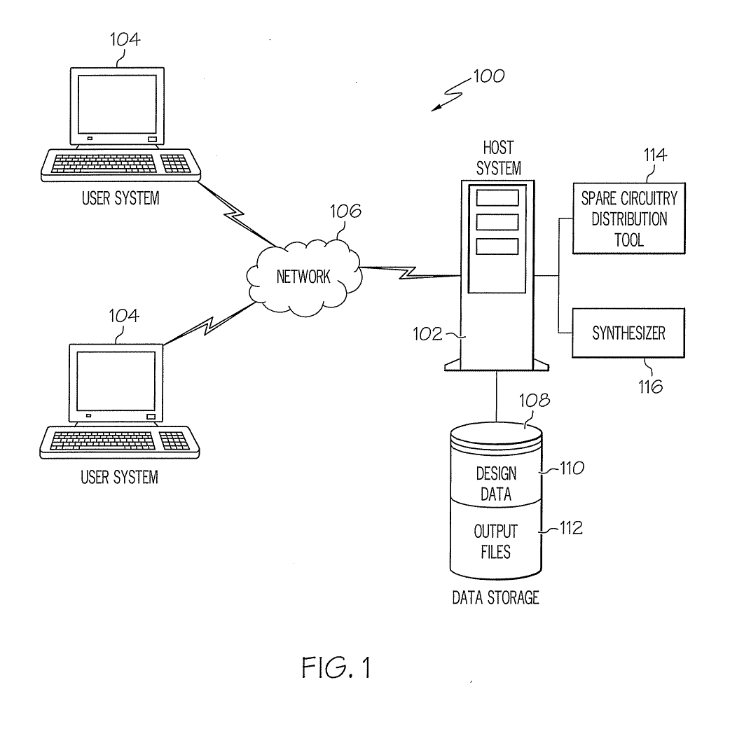

Turning now to the drawings, it will be seen that in FIG. 1 there is a block diagram of a system 100 upon which spare circuitry distribution in an integrated circuit design is implemented in an exemplary embodiment. The system 100 of FIG. 1 includes a host system 102 in communication with user systems 104 over a network 106. The host system 102 may be a high-speed processing device (e.g., a mainframe computer), including a processing circuit for executing instructions, which handles processing requests from user systems 104. In an exemplary embodiment, the host system 102 functions as an application server and a data management server for integrated circuit design and development activities. User systems 104 may comprise desktop or general-purpose computer devices that generate data and processing requests, such as integrated circuit synthesis, placement, routing, and spare circuitry distribution requests. While only a single host system 102 is shown in FIG. 1, it will be understood that multiple host systems may be implemented, each in communication with one another via direct coupling or via one or more networks. For example, multiple host systems may be interconnected through a distributed network architecture. The single host system 102 may also represent a cluster of hosts accessing a common data store, e.g., via a clustered file system that is backed by a data storage device 108. In an alternate exemplary embodiment, the host system 102 is directly user accessible without communication through the network 106, e.g., where the host system 102 is embodied in a desktop computer or workstation.

The network 106 may be any type of communications network known in the art. For example, the network 106 may be an intranet, extranet, or an internetwork, such as the Internet, or a combination thereof. The network 106 can include wireless, wired, or fiber optic links.

The data storage device 108 refers to any type of storage and may comprise one or more secondary storage elements, e.g., a hard disk drive or tape storage system that is external to the host system 102. In an alternate exemplary embodiment, the data storage device 108 is internal to the host system 102. Types of data that may be stored in the data storage device 108 include databases and/or files of design data 110, as well as output files 112. It will be understood that the data storage device 108 shown in FIG. 1 is provided for purposes of simplification and ease of explanation and is not to be construed as limiting in scope. To the contrary, there may be multiple data storage devices utilized by the host system 102.

In an exemplary embodiment, the host system 102 executes various applications, including a spare circuitry distribution tool (SCDT) 114 and a synthesizer 116. Other applications, e.g., electronic design automation (EDA) software, business applications, a web server, etc., may also be implemented by the host system 102 as dictated by the needs of the enterprise of the host system 102. The SCDT 114 interacts with databases and/or files stored on the data storage device 108, such as the design data 110, generating the output files 112. The SCDT 114 may also interact with the synthesizer 116. In an alternate exemplary embodiment, the synthesizer 116 reads and writes files to the data storage device 108, passing data to the SCDT 114 through files or data structures. In an exemplary embodiment, the design data 110 include one or more Very-high-speed integrated circuit Hardware Description Language (VHDL) files providing design descriptions for an integrated circuit design. The design data 110 may also include an abstract containing physical cell placement information defining the physical area available for circuitry placement within the integrated circuit design. All or a portion of the SCDT 114 and the synthesizer 116 may be located on the user systems 104 with processing shared between the user systems 104 and the host system 102, e.g., a distributed computing architecture. In addition, all or a portion of the data utilized by the SCDT 114 and the synthesizer 116 may be located on the user systems 104.

In an exemplary embodiment, the user systems 104 access the host system 102 to request spare circuitry distribution while designing an integrated circuit. The user systems 104 may also access the host system 102 to create or modify the design data 110 using other EDA software (not depicted). In an exemplary embodiment, the SCDT 114 is capable of analyzing the design data 110 to determine a spare circuitry distribution for the integrated circuit design. The SCDT 114 and the synthesizer 116 may each be implemented as a stand-alone application, a plug-in, a module, or an executable script in a development environment. The SCDT 114 and the synthesizer 116 can also be combined or further subdivided in any combination. For example, the SCDT 114 may be a module integrated with the synthesizer 116. In an exemplary embodiment, when the host system 102 receives a request to execute the SCDT 114, the design data 110 is read from the data storage device 108 and received by the SCDT 114. The SCDT 114 parses the design data 110 to determine target placement locations for the spare circuitry. Either the SCDT 114 or the synthesizer 116 may shift the location of the spare circuitry from each target placement location towards a nearest clock block within the integrated circuit design, with the results of the updated integrated circuit design output to the output files 112.

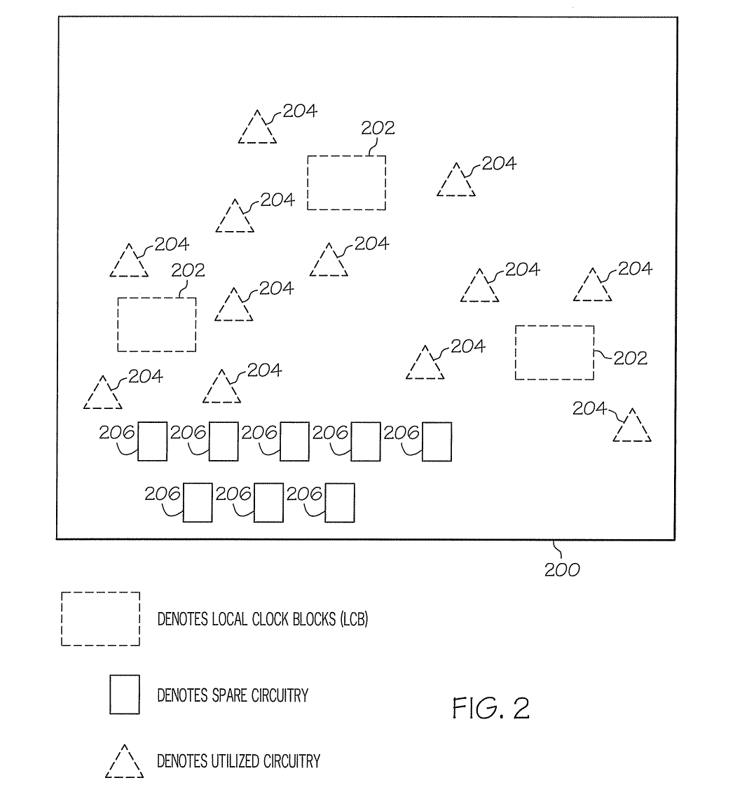

Turning now to FIG. 2, an exemplary distribution diagram of an integrated circuit 200 is depicted. The integrated circuit 200 includes multiple local clock blocks 202, utilized circuitry 204, and spare circuitry 206. The local clock blocks 202 may provide localized clocking to macros and other circuits that are run at a different rate than a global clock (not depicted). For example, a global clock may run at 50 MHz, while a local clock block 202 can step up the clock frequency to 200 MHz, step down the clock frequency to 25 MHz, or simply buffer and resynchronize the global clock. The utilized circuitry 204 represents circuits that are non-spare circuits. The spare circuitry 206 represents circuits that are not yet designated for a specific purpose within the integrated circuit 200. The integrated circuit 200 and the elements within the integrated circuit 200 depict one example of a distribution of elements within an integrated circuit design. As can be seen in FIG. 2, the spare circuitry 206 is clustered at the lower left portion of the integrated circuit 200. This distribution of the spare circuitry 206 may occur if the SCDT 114 of FIG. 1 is not executed to balance the distribution. As previously described, leaving the integrated circuit 200 with this clustered spare circuitry 206 distribution can create timing and routing issues when the spare circuitry 206 is interfaced with the utilized circuitry 204 at a great distance, such as the utilized circuitry 204 in the upper portion of the integrated circuit 200.

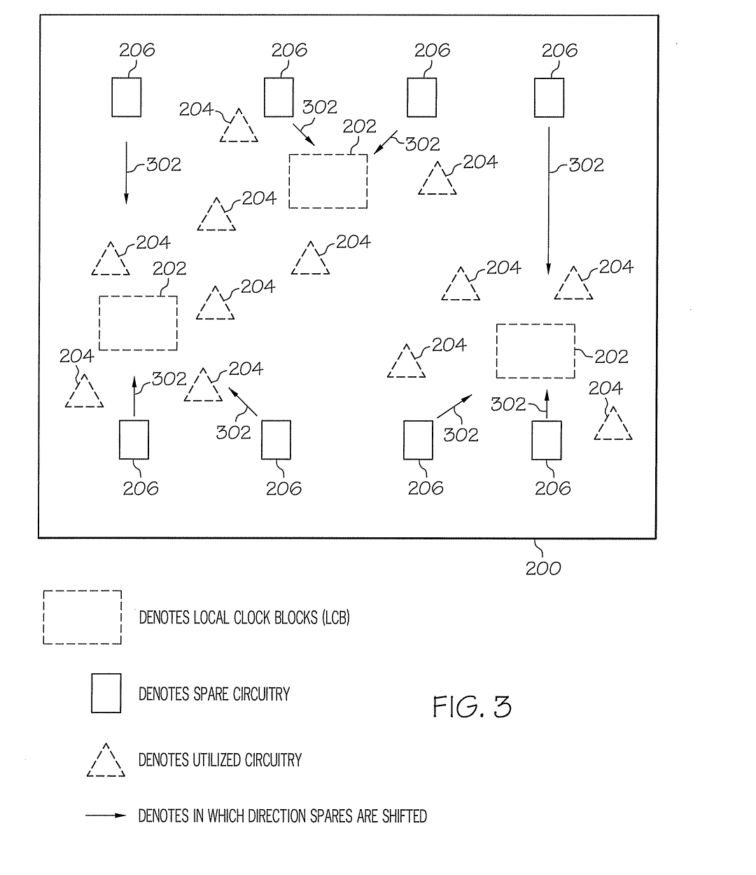

Through executing the SCDT 114 of FIG. 1, the distribution of the spare circuitry 206 in the integrated circuit 200 is balanced as depicted in FIG. 3. FIG. 3 illustrates the spare circuitry 206 in target placement locations as determined by the SCDT 114 of FIG. 1. The SCDT 114 of FIG. 1 determines the target placement locations through information extracted from the design data 110 of FIG. 1. In an exemplary embodiment, the SCDT 114 of FIG. 1 identifies the spare circuitry 206 in descriptions of spare circuitry in one or more VHDL files. The descriptions of spare circuitry may be identified through naming conventions of entities in the VHDL files, for example, entities with names including “_spr”. The SCDT 114 of FIG. 1 also analyzes physical area available for circuitry placement, which may be included in the design data 110 of FIG. 1 as an abstract containing physical cell placement information. In an exemplary embodiment, the SCDT 114 of FIG. 1 establishes a grid coordinate system in the physical area available for circuitry placement to determine target placement location coordinates for the spare circuitry 206. SCDT 114 of FIG. 1 evenly distributes the spare circuitry 206, also accounting for other placement constraints. For example, if the spare circuitry 206 includes latches and the physical area available for circuitry placement extracted from the design data 110 of FIG. 1 indicates that latches can only be placed near the periphery of the integrated circuit 200, then the target placement locations can account for this constraint. In an exemplary embodiment, the target placement locations are balanced to create an approximately even distribution of the spare circuitry 206 within the integrated circuit 200. The target location for the spare circuitry 206 can be determined through comparing the physical size of the spare circuitry 206 to the physical size of the integrated circuit 200 and establishing coordinates for the spare circuitry 206 relative to the integrated circuit 200 such that the distribution is approximately even. For example, the target placement locations may approximate a checkerboard pattern.

In an exemplary embodiment, after the target placement locations for the spare circuitry 206 are determined, the spare circuitry 206 is shifted in location to account for the placement of other elements within the integrated circuit 200. Shifting the spare circuitry 206 towards the local clock blocks 202 increases that probability that the spare circuitry 206 will be positioned near the utilized circuitry 204 that will interface with the spare circuitry 206. Each arrow 302 indicates the direction in which the spare circuitry 206 is shifted. The distance that the spare circuitry 206 is shifted may be controlled through a relative weighting to adjust the strength of attraction between the spare circuitry 206 and the nearest local clock block 202. For example, the relative weighting may be set to 50%, shifting the spare circuitry 206 in the direction indicated by each arrow 302 within approximately half of the distance between the spare circuitry 206 and the local clock block 202. The relative weighting may be user programmable. In an exemplary embodiment, the SCDT 114 of FIG. 1 performs the shifting of the spare circuitry 206 toward the local clock blocks 202. In an alternate exemplary embodiment, the synthesizer 116 of FIG. 1 performs the shifting of the spare circuitry 206 toward the local clock blocks 202. The result of the location shifting may be output as an updated integrated circuit design in the output files 112 of FIG. 1. In an exemplary embodiment, the synthesizer 116 of FIG. 1 creates a definition of a physical implementation of the updated integrated circuit design. Device programmers or other manufacturing tools (not depicted) can use the physical implementation definition to create a physical embodiment of the integrated circuit 200.

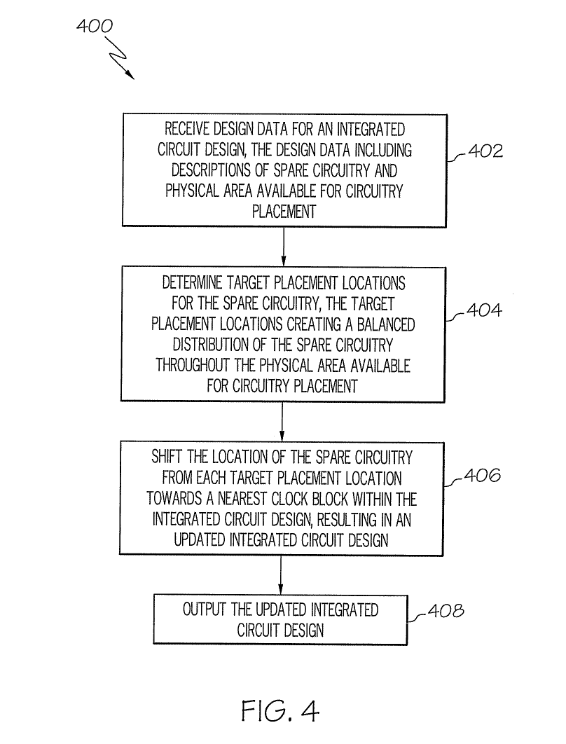

Turning now to FIG. 4, a process 400 for spare circuitry distribution in an integrated circuit design will now be described in accordance with an exemplary embodiment in reference to the system 100 of FIG. 1. In an exemplary embodiment, the host system 102 executes the SCDT 114 to distribute spare circuitry in an integrated circuit design, such as the integrated circuit 200 of FIGS. 2 and 3. Data for the integrated circuit design may be stored in the design data 110 on the data storage device 108.

At block 402, the SCDT 114 receives design data 110 for the integrated circuit design. In an exemplary embodiment, the design data includes descriptions of spare circuitry and physical area available for circuitry placement. The spare circuitry can be a latch, a buffer, a clocking structure, or other circuit structures known in the art. The descriptions of spare circuitry may be received from one or more VHDL files as part of the design data 110. The physical area available for circuitry placement may be received from an abstract containing physical cell placement information as part of the design data 110.

At block 404, the SCDT 114 determines target placement locations for the spare circuitry. The target placement locations create a balanced distribution of the spare circuitry throughout the physical area available for circuitry placement. In an exemplary embodiment, the target placement locations for the spare circuitry includes distributing the spare circuitry evenly using a grid coordinate system in the physical area available for circuitry placement. The balanced distribution need not be perfectly symmetric and may take other factors into account, such as preferred regions of the integrated circuit to locate spare circuitry. For example, the target placement locations for the spare circuitry may be closer to the periphery of the integrated circuit, as depicted in FIG. 3. In an alternate exemplary embodiment, the balanced distribution approximates a checkerboard pattern.

At block 406, the SCDT 114 shifts the location of the spare circuitry from the each target placement location towards a nearest clock block within the integrated circuit design, resulting in an updated integrated circuit design. The clock block may be a local clock block, such as the local clock blocks 202 depicted in FIGS. 2 and 3. In an alternate exemplary embodiment the synthesizer 116 shifts the location of the spare circuitry from each target placement location towards a nearest clock block while synthesizing the integrated circuit. Shifting the location of the spare circuitry may apply a relative weighting to adjust the strength of attraction between the spare circuitry and the nearest clock block.

At block 408, the SCDT 114 outputs the updated integrated circuit design. In an exemplary embodiment, the synthesizer 116 creates a physical implementation definition of the updated integrated circuit design. The output may be formatted as files or data for storage in the data storage device 108 as the output files 112. Manufacturing tools or device programmers (not depicted) can then use the output files 112 to create a physical embodiment of the integrated circuit.

Technical effects include spare circuitry distribution in an integrated circuit design. The distribution of the spare circuitry is balanced to spread the spare circuitry in an approximately even manner throughout the integrated circuit design. An advantage includes more efficient allocation of spare circuitry within an integrated circuit design. Further technical effects include determining target placement locations for the spare circuitry and shifting the spare circuitry from the target locations towards clock blocks. Placing the spare circuitry near clock blocks may reduce wire length and improve signal-timing margin when the spare circuitry is integrated with other circuits. Improving the placement of spare circuitry in an automated manner may reduce human designer effort, while increasing productivity and efficiency. Automated distribution of spare circuitry may enhance flexibility to respond to engineering change orders through placing spare circuitry in areas of the integrated circuit where it is most likely to be needed and utilized.

As described above, embodiments can be embodied in the form of computer-implemented processes and apparatuses for practicing those processes. In an exemplary embodiment, the invention is embodied in computer program code executed by one or more network elements. Embodiments include computer program code containing instructions embodied in tangible media, such as floppy diskettes, CD-ROMs, hard drives, universal serial bus (USB) drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for spare circuitry distribution in an integrated circuit design, comprising:
receiving design data for the integrated circuit design, the design data including descriptions of spare circuitry and physical area available for circuitry placement;
determining target placement locations for the spare circuitry, the target placement locations creating a balanced distribution of the spare circuitry throughout the physical area available for circuitry placement;
shifting the location of the spare circuitry from each target placement location towards a nearest clock block within the integrated circuit design, resulting in an updated integrated circuit design; and
outputting the updated integrated circuit design.

2. The method of claim 1 further comprising:
synthesizing the updated integrated circuit design to create a definition of a physical implementation of the updated integrated circuit design.

3. The method of claim 1 wherein shifting the location of the spare circuitry is performed by a synthesizer.

4. The method of claim 1 wherein determining the target placement locations for the spare circuitry includes distributing the spare circuitry evenly using a grid coordinate system in the physical area available for circuitry placement.

5. The method of claim 1 wherein the descriptions of spare circuitry are received from one or more Very-high-speed integrated circuit Hardware Description Language (VHDL) files, and the physical area available for circuitry placement is received from an abstract containing physical cell placement information.

6. The method of claim 1 wherein shifting the location of the spare circuitry applies a relative weighting to adjust the strength of attraction between the spare circuitry and the nearest clock block.

7. The method of claim 1 wherein the clock block is a local clock block.

8. The method of claim 1 wherein the spare circuitry is at least one of a latch, a buffer, and a clocking structure.

9. A system for spare circuitry distribution in an integrated circuit design, comprising:
a data storage device holding design data for the integrated circuit design, the design data including descriptions of spare circuitry and physical area available for circuitry placement; and
a host system in communication with the data storage device, the host system executing a spare circuitry distribution tool (SCDT), the SCDT performing:
receiving the design data;
determining target placement locations for the spare circuitry, the target placement locations creating a balanced distribution of the spare circuitry throughout the physical area available for circuitry placement;
shifting the location of the spare circuitry from each target placement location towards a nearest clock block within the integrated circuit design, resulting in an updated integrated circuit design; and
outputting the updated integrated circuit design.

10. The system of claim 9 further comprising a synthesizer, the synthesizer performing:
synthesizing the updated integrated circuit design to create a definition of a physical implementation of the updated integrated circuit design.

11. The system of claim 9 wherein determining the target placement locations for the spare circuitry includes distributing the spare circuitry evenly using a grid coordinate system in the physical area available for circuitry placement.

12. The system of claim 9 wherein the descriptions of spare circuitry are received from one or more VHDL files, and the physical area available for circuitry placement is received from an abstract containing physical cell placement information.

13. The system of claim 9 wherein the clock block is a local clock block.

14. The system of claim 9 wherein the spare circuitry is at least one of a latch, a buffer, and a clocking structure.

15. The system of claim 9 wherein shifting the location of the spare circuitry applies a relative weighting to adjust the strength of attraction between the spare circuitry and the nearest clock block.

16. A computer program product for spare circuitry distribution in an integrated circuit design, the computer program product comprising:
a storage medium readable by a processing circuit and storing instructions for execution by the processing circuit for implementing a method, the method comprising:
receiving design data for the integrated circuit design, the design data including descriptions of spare circuitry and physical area available for circuitry placement;
determining target placement locations for the spare circuitry, the target placement locations creating a balanced distribution of the spare circuitry throughout the physical area available for circuitry placement;
shifting the location of the spare circuitry from each target placement location towards a nearest clock block within the integrated circuit design, resulting in an updated integrated circuit design; and
outputting the updated integrated circuit design.

17. The computer program product of claim 16 wherein the method further comprises:
synthesizing the updated integrated circuit design to create a definition of a physical implementation of the updated integrated circuit design.

18. The computer program product of claim 16 wherein determining the target placement locations for the spare circuitry includes distributing the spare circuitry evenly using a grid coordinate system in the physical area available for circuitry placement.

19. The computer program product of claim 16 wherein the descriptions of spare circuitry are received from one or more VHDL files, and the physical area available for circuitry placement is received from an abstract containing physical cell placement information.

20. The computer program product of claim 16 wherein shifting the location of the spare circuitry applies a relative weighting to adjust the strength of attraction between the spare circuitry and the nearest clock block.
